(19) United States
(12) Patent Application Publication
(10) Pub. No.: US 2020/0361504 A1
(43) Pub. Date: Nov. 19, 2020

(54) Wheeled Stepladder Platform Apparatus

(71) Applicant: Daniel Prescott, Nashville, TN (US)

(72) Inventor: Daniel Prescott, Nashville, TN (US)

(21) Appl. No.: 16/414,929

(22) Filed: May 17, 2019

(51) Int. Cl. B62B 3/00; B62B 5/04; B60B 33/00; E06C 5/02

(52) U.S. Cl. CPC B62B 3/00; B62B 5/0457; E06C 1/16; E06C 5/02; B60B 33/0078; B60B 33/0068

(57) ABSTRACT

A wheeled stepladder platform apparatus for easily moving a stepladder includes a base frame having a left side, a right side, a back side, and a front side forming a rectangle and a crossmember extending from the back side to the front side in parallel opposition to the left side. Each of the left side, the right side, the back side, the front side, and the crossmember is L-shaped and has a vertical portion and a horizontal portion. The base frame is configured to support a stepladder on the horizontal portion. The base frame comprises a back left section, a front left section, a back right section, a front right section, and a plurality of joiner sections joined with a plurality of hardware through a plurality of mounting apertures. A plurality of wheels is coupled to the base frame.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to stepladder accessories and more particularly pertains to a new stepladder accessory for easily moving a stepladder.

### BRIEF SUMMARY OF THE INVENTION

An embodiment of the disclosure meets the needs presented above by generally comprising a base frame, the base frame having a left side, a right side, a back side, a front side, and a crossmember. Each of the left side, the right side, the back side, the front side, and the crossmember is L-shaped and has a vertical portion and a horizontal portion. The left side, the right side, the back side, and the front side form a rectangle with the horizontal portion extending in from an inner surface of the base frame. The crossmember extends from the back side to the front side in parallel opposition to the left side with the horizontal portion of the crossmember extending towards the left side. The base frame is configured to support a stepladder on the horizontal portion with a back left foot of the stepladder resting on the left side, the crossmember, and the back side, a front left foot of the stepladder resting on the left side, the crossmember, and the back side, a back right foot of the stepladder resting on the right side and the back side, and a front right foot of the stepladder resting on the right side and the front side. The vertical portion and the horizontal portion have a plurality of mounting apertures extending from the inner surface through an outer surface. The base frame comprises a back left section, a front left section, a back right section, a front right section, and a plurality of joiner sections. The back left section comprises a left side back half, a back side left half, and a crossmember back half. The front left section comprises a left side front half, a front side left half, and a crossmember front half. The back right section comprises a right side back half and a back side right half. The front right section comprises a right side front half and a front side right half. The plurality of joiner sections comprises a left joiner section, a right joiner section, a back joiner section, a front joiner section, and a crossmember joiner section. The plurality of mounting apertures of each of the joiner sections and the plurality of mounting apertures of each of the back left section, the front left section, the back right section, and the front right section selectively receive a plurality of mounting hardware to selectively engage the left joiner section between the left side back half and the left side front half, the right joiner section between the right side back half and the right side front half, the back joiner section between the back side left half and the back side right half, the front joiner section between the front side left half and the front side right half, and the crossmember joiner section between the crossmember back half and the crossmember front half. A plurality of wheels is coupled to the base frame. The plurality of wheels comprises a back left wheel coupled to the left side and the back side, a front left wheel coupled to the left side and the front side, a back right wheel coupled to the right side and the back side, and a front right wheel coupled to the right side and the front side.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a wheeled stepladder platform apparatus according to an embodiment of the disclosure.

FIG. 2 is an exploded top plan view of an embodiment of the disclosure.

FIG. 3 is a bottom plan view of an embodiment of the disclosure.

FIG. 4 is a front elevation view of an embodiment of the disclosure.

FIG. 5 is an in-use view of an embodiment of the disclosure.

### DETAILED DESCRIPTION OF THE INVENTION

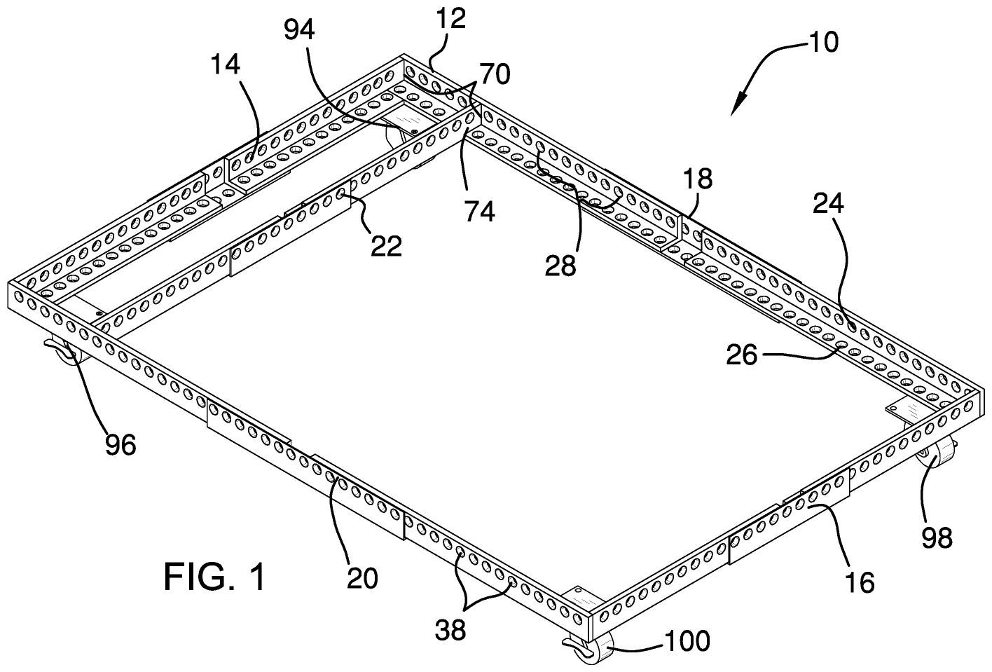

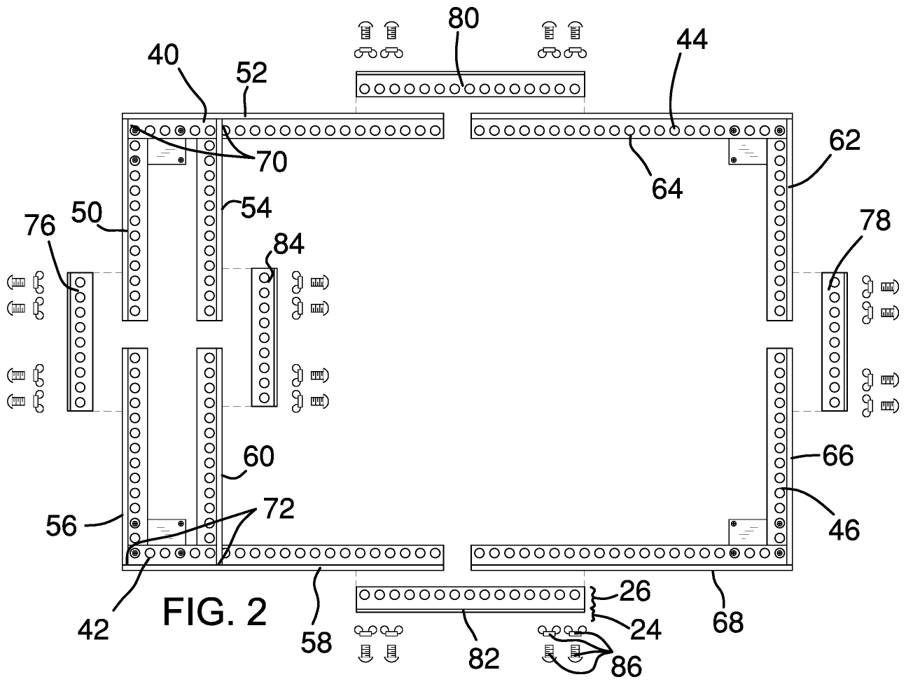

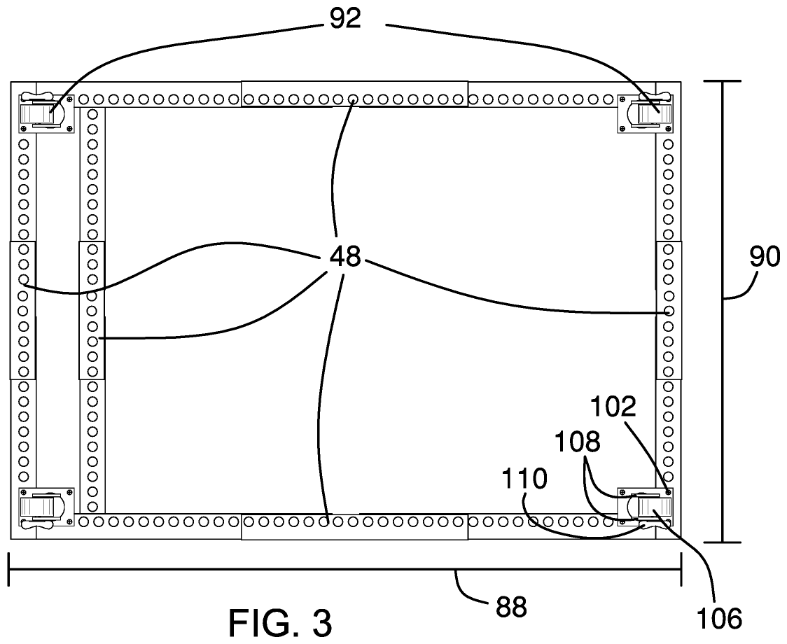

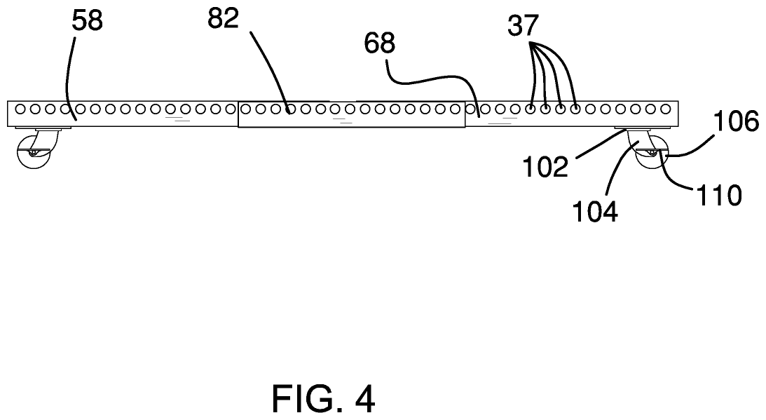

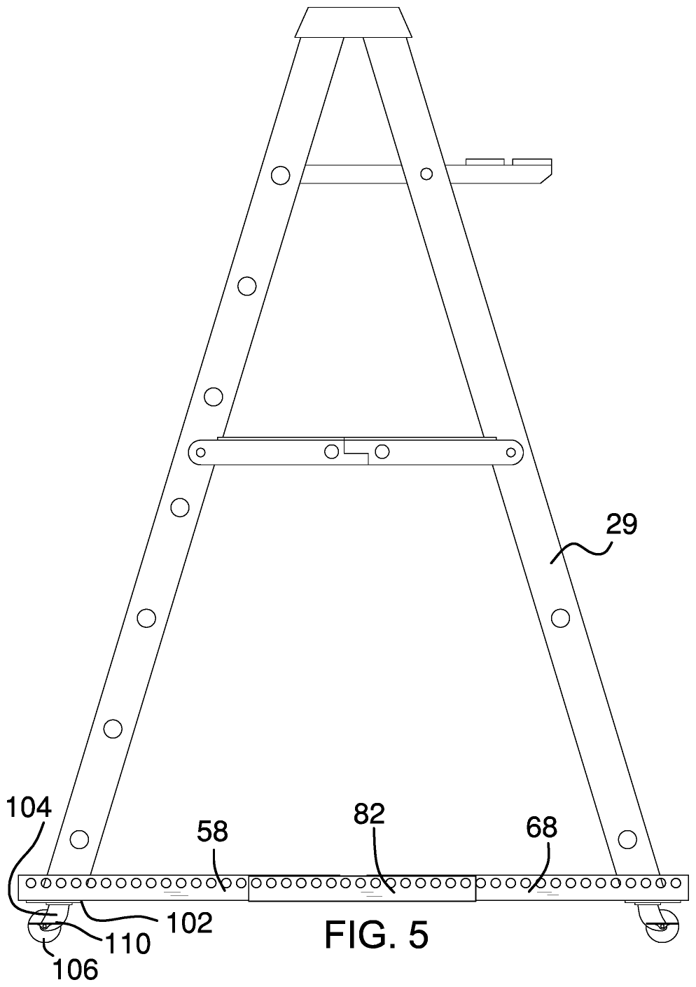

With reference now to the drawings, and in particular to FIGS. 1 through 5 thereof, a new stepladder accessory embodying the principles and concepts of an embodiment of the disclosure and generally designated by the reference numeral 10 will be described.

As best illustrated in FIGS. 1 through 5, the wheeled stepladder platform apparatus 10 generally comprises a base frame 12 having a left side 14, a right side 16, a back side 18, a front side 20, and a crossmember 22. Each of the left side 14, the right side 16, the back side 18, the front side 20, and the crossmember 22 is L-shaped and has a vertical portion 24 and a horizontal portion 26. The left side 14, the right side 16, the back side 18, and the front side 20 form a rectangle. The horizontal portion 26 extends in from an inner surface 28 of the base frame. The crossmember 22 extends from the back side 18 to the front side 20 in parallel opposition to the left side 14 with the horizontal portion 26 of the crossmember 22 extending towards the left side 14. The base frame 12 is configured to support a stepladder 29 on the horizontal portion 26 with a back left foot of the stepladder resting on the left side 14, the crossmember 22, and the back side 18, a front left foot of the stepladder resting on the left side 14, the crossmember 22, and the back side 18, a back right foot of the stepladder resting on the right side 16 and the back side 18, and a front right foot of the stepladder resting on the right side 16 and the front side 20. The vertical portion 24 and the horizontal portion 26 have a plurality of mounting apertures 37 extending from the inner surface 28 through an outer surface 38. The plurality of mounting apertures 37 may be arranged in a continuous, evenly spaced array and also serve to reduce the weight of the base frame 12.

The base frame 12 comprises a back left section 40, a front left section 42, a back right section 44, a front right section 46, and a plurality of joiner sections 48. The back left section 40 comprises a left side back half 50, a back side left half 52, and a crossmember back half 54. The front left section 42 comprises a left side front half 56, a front side left half 58, and a crossmember front half 60. The back right section 44 comprises a right side back half 62 and a back side right half 64. The front right section 46 comprises a right side front half 66 and a front side right half 68. The horizontal portion 26 of a back end 70 of each of the left side back half 50, the right side back half 62, and the crossmember back half 54, and a front end 72 of each of the left side front half 56, the right side front half 66, and the crossmember front half 60 has a notch 74 to allow the horizontal portions 26 of the back left section 40, the front left section 42, the back right section 44, and the front right section 46 to be coplanar.

The plurality of joiner sections 48 comprises a left joiner section 76, a right joiner section 78, a back joiner section 80, a front joiner section 82, and a crossmember joiner section 84. The plurality of mounting apertures 37 of each of the joiner sections 48 and each of the back left section 40, the front left section 42, the back right section 44, and the front right section 46 selectively receive a plurality of mounting hardware 86 to selectively engage the left joiner section 76 between the left side back half 50 and the left side front half 56, the right joiner section 78 between the right side back half 62 and the right side front half 66, the back joiner section 80 between the back side left half 52 and the back side right half 64, the front joiner section 82 between the front side left half 58 and the front side right half 68, and the crossmember joiner section 84 between the crossmember back half 54 and the crossmember front half 60. A height of the vertical portions 24 and a width of the horizontal portions 26 of the plurality of joiner sections 48 are greater than a height of the vertical portions 24 and a width of the horizontal portions 26 of the back left section 40, the front left section 42, the back right section 44, and the front right section 46. The inner surface 28 of the plurality of joiner sections 48 receives the outer surface 38 of the back left section 40, the front left section 42, the back right section 44, and the front right section 46 to align the plurality of mounting apertures 37. The amount of overlap of the front side left half 58 and the front side right half 68 with the front joiner section 82 and the back side left half 52 and the back side right half 64 with the back joiner section 80 affects an overall length 88 of the base frame 12. The amount of overlap of the left side front half 56 and the left side back half 50 with the left joiner section 76 and the right side front half 66 and the right side back half 62 with the right joiner section 78 affecting an overall width 90 of the base frame 12.

A plurality of wheels 92 is coupled to the base frame 12. The plurality of wheels 92 comprises a back left wheel 94 coupled to the left side 14 and the back side 18, a front left wheel 96 coupled to the left side 14 and the front side 20, a back right wheel 98 coupled to the right side 16 and the back side 18, and a front right wheel 100 coupled to the right side 16 and the front side 20. Each of the plurality of wheels 92 has a platform 102 coupled to the outer surface 38 of the horizontal portion 26 of the base frame. A fork 104 is rotatably coupled to the platform 102 and a roller 106 is coupled between a pair of arms 108 of the fork. A lock 110 is coupled to the fork 104 and is selectively engageable with the roller 106 to lock and alternatively free the roller 106, allowing the base platform 12 to either be secured in place or alternatively rolled to be moved.

In use, the stepladder 29 is placed on the base frame 12 and the overall length 88 and the overall width 90 are adjusted to fit snugly around the back left foot, the front left foot, the back right foot, and the front right foot. The lock 110 of each of the plurality of wheels is engaged when the stepladder 29 is in use and disengaged when the stepladder needs to be wheeled to another location.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wheeled stepladder platform apparatus comprising:
a base frame, the base frame having a left side, a right side, a back side, a front side, and a crossmember, each of the left side, the right side, the back side, the front side, and the crossmember being L-shaped and having a vertical portion and a horizontal portion, the left side, the right side, the back side, and the front side forming a rectangle, the horizontal portion extending in from an inner surface of the base frame, the crossmember extending from the back side to the front side in parallel opposition to the left side with the horizontal portion of the crossmember extending towards the left side, the base frame being configured to support a stepladder on the horizontal portion with a back left foot of the stepladder resting on the left side, the crossmember, and the back side, a front left foot of the stepladder resting on the left side, the crossmember, and the back side, a back right foot of the stepladder resting on the right side and the back side, and a front right foot of the stepladder resting on the right side and the front side, the vertical portion and the horizontal portion having a plurality of mounting apertures extending from the inner surface through an outer surface, the base frame comprising:
a back left section comprising a left side back half, a back side left half, and a crossmember back half;
a front left section comprising a left side front half, a front side left half, and a crossmember front half;
a back right section comprising a right side back half and a back side right half;
a front right section comprising a right side front half and a front side right half; and
a plurality of joiner sections, the plurality of joiner sections comprising a left joiner section, a right joiner section, a back joiner section, a front joiner section, and a crossmember joiner section, the plurality of mounting apertures of each of the joiner sections and the plurality of mounting apertures of each of the back left section, the front left section, the back right section, and the front right section selectively receiving a plurality of mounting hardware to selectively engage the left joiner section between the left side back half and the left side front half, the right joiner section between the right side back half and the right side front half, the back joiner section between the back side left half and the back side right half, the front joiner section between the front side left half and the front side right half, and the crossmember joiner section between the crossmember back half and the crossmember front half; and
a plurality of wheels coupled to the base frame, the plurality of wheels comprising a back left wheel coupled to the left side and the back side, a front left wheel coupled to the left side and the front side, a back right wheel coupled to the right side and the back side, and a front right wheel coupled to the right side and the front side.

2. The wheeled stepladder platform apparatus of claim 1 further comprising each of the plurality of wheels having a platform coupled to the outer surface of the horizontal portion of the base frame, a fork coupled to the platform, a roller coupled between a pair of arms of the fork, and a lock coupled to the fork and selectively engageable with the roller to lock and alternatively free the roller.

3. The wheeled stepladder platform apparatus of claim 2 further comprising the fork being rotatably coupled to the platform.

4. The wheeled stepladder platform apparatus of claim 1 further comprising the horizontal portion of a back end of each of the left side back half, the right side back half, and the crossmember back half, and a front end of each of the left side front half, the right side front half, and the crossmember front half having a notch to allow the horizontal portions of the back left section, the front left section, the back right section, and the front right section to be coplanar.

5. The wheeled stepladder platform apparatus of claim 1 further comprising a height of the vertical portions and a width of the horizontal portions of the plurality of joiner sections being greater than a height of the vertical portions and a width of the horizontal portions of the back left section, the front left section, the back right section, and the front right section, the inner surface of the plurality of joiner sections receiving the outer surface of the back left section, the front left section, the back right section, and the front right section to align the plurality of mounting apertures, the amount of overlap of the front side left half and the front side right half with the front joiner section and the back side left half and the back side right half with the back joiner section affecting an overall length of the base frame, the amount of overlap of the left side front half and the left side back half with the left joiner section and the right side front half and the right side back half with the right joiner section affecting an overall width of the base frame.

6. A wheeled stepladder platform apparatus comprising:
a base frame, the base frame having a left side, a right side, a back side, a front side, and a crossmember, each of the left side, the right side, the back side, the front side, and the crossmember being L-shaped and having a vertical portion and a horizontal portion, the left side, the right side, the back side, and the front side forming a rectangle, the horizontal portion extending in from an inner surface of the base frame, the crossmember extending from the back side to the front side in parallel opposition to the left side with the horizontal portion of the crossmember extending towards the left side, the base frame being configured to support a stepladder on the horizontal portion with a back left foot of the stepladder resting on the left side, the crossmember, and the back side, a front left foot of the stepladder resting on the left side, the crossmember, and the back side, a back right foot of the stepladder resting on the right side and the back side, and a front right foot of the stepladder resting on the right side and the front side, the vertical portion and the horizontal portion having a plurality of mounting apertures extending from the inner surface through an outer surface, the base frame comprising:
a back left section comprising a left side back half, a back side left half, and a crossmember back half;
a front left section comprising a left side front half, a front side left half, and a crossmember front half;
a back right section comprising a right side back half and a back side right half;
a front right section comprising a right side front half and a front side right half;
wherein the horizontal portion of a back end of each of the left side back half, the right side back half, and the crossmember back half, and a front end of each of the left side front half, the right side front half, and the crossmember front half has a notch to allow the horizontal portions of the back left section, the front left section, the back right section, and the front right section to be coplanar; and
a plurality of joiner sections, the plurality of joiner sections comprising a left joiner section, a right joiner section, a back joiner section, a front joiner section, and a crossmember joiner section, the plurality of mounting apertures of each of the joiner sections and the plurality of mounting apertures of each of the back left section, the front left section, the back right section, and the front right section selectively receiving a plurality of mounting hardware to selectively engage the left joiner section between the left side back half and the left side front half, the right joiner section between the right side back half and the right side front half, the back joiner section between the back side left half and the back side right half, the front joiner section between the front side left half and the front side right half, and the crossmember joiner section between the crossmember back half and the crossmember front half, a height of the vertical portions and a width of the horizontal portions of the plurality of joiner sections being greater than a height of the vertical portions and a width of the horizontal portions of the back left section, the front left section, the back right section, and the front right section, the inner surface of the plurality of joiner sections receiving the outer surface of the back left section, the front left section, the back right section, and the front right section to align the plurality of mounting apertures, the amount of overlap of the front side left half and the front side right half with the front joiner section and the back side left half and the back side right half with the back joiner section affecting an overall length of the base frame, the amount of overlap of the left side front half and the left side back half with the left joiner section and the right side front half and the right side back half with the right joiner section affecting an overall width of the base frame; and
a plurality of wheels coupled to the base frame, the plurality of wheels comprising a back left wheel coupled to the left side and the back side, a front left wheel coupled to the left side and the front side, a back right wheel coupled to the right side and the back side, and a front right wheel coupled to the right side and the front side, each of the plurality of wheels having a platform coupled to the outer surface of the horizontal portion of the base frame, a fork rotatably coupled to the platform, a roller coupled between a pair of arms of the fork, and a lock coupled to the fork and selectively engageable with the roller to lock and alternatively free the roller.

7. A stepladder and wheeled stepladder platform apparatus combination comprising:
a stepladder;
a base frame, the base frame having a left side, a right side, a back side, a front side, and a crossmember, each of the left side, the right side, the back side, the front side, and the crossmember being L-shaped and having a vertical portion and a horizontal portion, the left side, the right side, the back side, and the front side forming a rectangle, the horizontal portion extending in from an inner surface of the base frame, the crossmember extending from the back side to the front side in parallel opposition to the left side with the horizontal portion of the crossmember extending towards the left side, the base frame supporting the stepladder on the horizontal portion with a back left foot of the stepladder resting on the left side, the crossmember, and the back side, a front left foot of the stepladder resting on the left side, the crossmember, and the back side, a back right foot of the stepladder resting on the right side and the back side, and a front right foot of the stepladder resting on the right side and the front side, the vertical portion and the horizontal portion having a plurality of mounting apertures extending from the inner surface through an outer surface, the base frame comprising:
a back left section comprising a left side back half, a back side left half, and a crossmember back half;
a front left section comprising a left side front half, a front side left half, and a crossmember front half;
a back right section comprising a right side back half and a back side right half;
a front right section comprising a right side front half and a front side right half;
wherein the horizontal portion of a back end of each of the left side back half, the right side back half, and the crossmember back half, and a front end of each of the left side front half, the right side front half, and the crossmember front half has a notch to allow the horizontal portions of the back left section, the front left section, the back right section, and the front right section to be coplanar; and
a plurality of joiner sections, the plurality of joiner sections comprising a left joiner section, a right joiner section, a back joiner section, a front joiner section, and a crossmember joiner section, the plurality of mounting apertures of each of the joiner sections and the plurality of mounting apertures of each of the back left section, the front left section, the back right section, and the front right section selectively receiving a plurality of mounting hardware to selectively engage the left joiner section between the left side back half and the left side front half, the right joiner section between the right side back half and the right side front half, the back joiner section between the back side left half and the back side right half, the front joiner section between the front side left half and the front side right half, and the crossmember joiner section between the crossmember back half and the crossmember front half, a height of the vertical portions and a width of the horizontal portions of the plurality of joiner sections being greater than a height of the vertical portions and a width of the horizontal portions of the back left section, the front left section, the back right section, and the front right section, the inner surface of the plurality of joiner sections receiving the outer surface of the back left section, the front left section, the back right section, and the front right section to align the plurality of mounting apertures, the amount of overlap of the front side left half and the front side right half with the front joiner section and the back side left half and the back side right half with the back joiner section affecting an overall length of the base frame, the amount of overlap of the left side front half and the left side back half with the left joiner section and the right side front half and the right side back half with the right joiner section affecting an overall width of the base frame; and
a plurality of wheels coupled to the base frame, the plurality of wheels comprising a back left wheel coupled to the left side and the back side, a front left wheel coupled to the left side and the front side, a back right wheel coupled to the right side and the back side, and a front right wheel coupled to the right side and the front side, each of the plurality of wheels having a platform coupled to the outer surface of the horizontal portion of the base frame, a fork rotatably coupled to the platform, a roller coupled between a pair of arms of the fork, and a lock coupled to the fork and selectively engageable with the roller to lock and alternatively free the roller.
